(19) United States
(12) Patent Application Publication
(10) Pub. No.: US 2010/0136814 A1
(43) Pub. Date: Jun. 3, 2010

(54) PACKING AND CONNECTOR HAVING THE SAME

(75) Inventors: Nobuyuki Sakamoto, Makinohara (JP); Keiko Ishida, Makinohara (JP); Kazuki Zaitsu, Makinohara (JP)

Correspondence Address: EDWARDS ANGELL PALMER & DODGE LLP, P.O. BOX 55874, BOSTON, MA, 02205, US

(73) Assignee: Yazaki Corporation, Tokyo (JP)

(21) Appl. No.: 12/452,400

(22) PCT Filed: May 16, 2008
(86) PCT No.: PCT/JP2008/059485

§ 371 Date: Dec. 29, 2009

(30) Foreign Application Priority Data
Jul. 10, 2007 (JP) 2007 180993

(51) Int. Cl. H01R 13/52

(52) U.S. Cl. 439/271

(57) ABSTRACT

[Problems] To provide a packing which makes it easy to connect the connector housing to which the packing is attached to the mating connector housing, and keeps a connecting area between the connector housing watertight, and to provide a connector having the packing.

[Means for Solving Problems] A connector 1 includes a male housing 17 and a packing 19. The male housing 17 is connected to a female connector housing. The packing 19 includes: a hard part 30 made of first elastic material, a center part thereof in a connecting direction K of the connector housings being in close contact with the connector housing 17 to form a V-shaped section; and a soft part 31 made of second elastic material softer than the first material, overlapped with the hard part 30 at the mating connector housing side, being in close contact with the mating connector housing.

### TECHNICAL FIELD

This invention relates to a packing used in a connector which is used for connecting electric wires, and a connector having the packing.

### BACKGROUND

A wiring harness used in a vehicle as a moving body includes a plurality of electric wires, and a connector attached to ends of the electric wires. Of course the electric wire is a covered electric wire having a conductive core wire and a cover for covering the core wire. The connector is connected to a mating connector or various electronic components. The wiring harness is arranged in a vehicle, and supplies electric power or signals to the electronic components through the connector connected to the mating connector and the electronic components.

As the above mentioned connector, so called waterproof connector, which is connected to the mating connector and both connectors connected to each other are watertight, may be used (for example, see Patent Document 1). Such a connector includes terminal fittings to be attached to the ends of the electric wire, and a connector housing for receiving the terminal fittings, and a packing made of elastic material and attached to the connector housing to keep the connector and the mating connector watertight.

The packing is made in a ring (frame) shape. The packing integrally includes a hard member formed in an inner periphery, and a soft member formed in an outer periphery and overlapped with the hard member. The hard and soft members are, respectively made of rubbery synthetic resin. Of course, the synthetic resin of the soft member is softer than the synthetic resin of the hard member.

In the connector disclosed in the Patent Document 1, the soft member is mounted in the outer periphery of the packing to make it easy to connect the connector to the mating connector (to reduce force to move the connector close to the mating connector when connecting to each other) by easily deforming the soft member of the connector.

[Patent Document 1] Japanese Published Patent Application No. 2002-151194

### DISCLOSURE OF THE INVENTION

### Problem to be Solved by the Invention

The synthetic resin of the outer periphery of the packing disclosed in the Patent Document 1 is softer than that of the inner periphery of the packing. Therefore, while the connector is connected to the mating connector, because the outer periphery is made of soft synthetic resin, sometimes liquid such as water is inserted into a connecting area between the connectors by deforming the outer periphery under a pressure of the liquid or a gas (when the gas in the connector leaks out of the connector, liquid such as water is inserted into the connecting area between the connector via a gap made by deforming the outer periphery) when the liquid such as water is to be inserted into the connecting part of the connectors, or the gas is to leak out from the connecting part of the connector under a differential pressure between the connecting part and the outside of the connector.

Accordingly, an object of the present invention is to provide a packing which makes it easy to connect the connector housing to which the packing is attached to the mating connector housing, and keeps a connecting area between the connector housing watertight, and to provide a connector having the packing.

### Means for Solving Problem

For attaining the object, according to claim 1 of the present invention, there is provided a packing made of elastic member and formed in a ring shape, and attached to the connector housing to keep a connecting area between the connector housing and a mating connector housing watertight,

the packing including:

a hard part made of first elastic material, a center part thereof in a connecting direction of the connector housings being in close contact with the connector housing to form a V-shaped section; and

a soft part made of second elastic material softer than the first material, overlapped with the hard part at the mating connector housing side, being in close contact with the mating connector housing.

According to claim 2 of the present invention, the packing as claimed in claim 1,

wherein a center part of the soft part in the connecting direction of the connector housings is formed in a convex shape toward the mating connector housing.

According to claim 3 of the present invention, a connector comprising:

a connector housing; and

a packing attached to the connector housing to keep a connecting area between the connector and a mating connector connected to the connector watertight,

wherein the packing is the packing as claimed in claim 1 or claim 2.

### EFFECT OF THE INVENTION

As explained the above, according to claim 1 of the present invention, because the hard part is formed in a V-shape section, and the soft part is overlapped with the hard part at the mating connector housing side, a gap is formed between the hard part and the connector housing. Therefore, while the connector housing is connected to the mating connector housing, when a differential pressure is generated between the connecting part and an outside of the connector and the liquid such as water is to be inserted into the connecting part and a gas in the connector housing is to leak out of the connector housing, pressure of the liquid or the gas deforms the packing to make an end of the hard part close to the mating housing. Thus, the soft part is in closer contact with the mating connector. Therefore, when the liquid such as water is to be inserted into the connecting part, or the gas is to leak out of the connector housing, the soft part is in closer contact with the mating connector so that the packing may make the connecting part surely watertight.

Further, because the soft part is overlapped with the hard part, when the connector housing is connected to the mating connector housing, the soft part is pushed by the mating connector housing and easily elastically deformed. Therefore, while the connector is easily connected to the mating connector, the packing surely makes the connecting part watertight.

According to claim 2 of the present invention, because the center part of the soft part is projected, the soft part is surely in close contact with the mating connector housing, and the packing surely makes the connecting part watertight.

According to claim 3 of the present invention, because the connector has the above-described packing, when a differential pressure is generated between the connecting part and the outside of the connector housing, the packing is elastically deformed to make the end of the hard part close to the mating connector housing. Therefore, the packing surely makes the connecting part watertight. Therefore, while the connector is easily connected to the mating connector, the packing surely makes the connecting area between the connector housings watertight.

### BRIEF DESCRIPTION OF DRAWINGS

FIG. 1 A perspective view showing a connector according to an embodiment of the present invention connected to a mating connector.

FIG. 2 A perspective view showing the connector shown in FIG. 1 separated from the mating connector.

FIG. 3 An exploded perspective view showing the connector shown in FIG. 1.

FIG. 4 A sectional view taken on line IV-IV of FIG. 1.

FIG. 5A A perspective view showing a packing used in the connector shown in FIG. 1.

FIG. 5B A perspective view showing a section of the packing shown in FIG. 5A.

FIG. 6 A sectional view showing a main part of the connector shown in FIG. 4.

FIG. 7 An enlarged sectional view showing VIII part of FIG. 4.

FIG. 8 A sectional view showing a state that pressure acts on a gap shown in FIG. 7.

FIG. 9 A sectional view showing the elastically deformed packing shown in FIG. 8.

### EXPLANATIONS OF LETTERS OR NUMERALS

1 waterproof connector (connector)
4 female housing (mating connector housing)
17 male housing (connector housing)
19 packing
30 hard part
31 soft part
K connecting direction

### BEST MODE FOR CARRYING OUT THE INVENTION

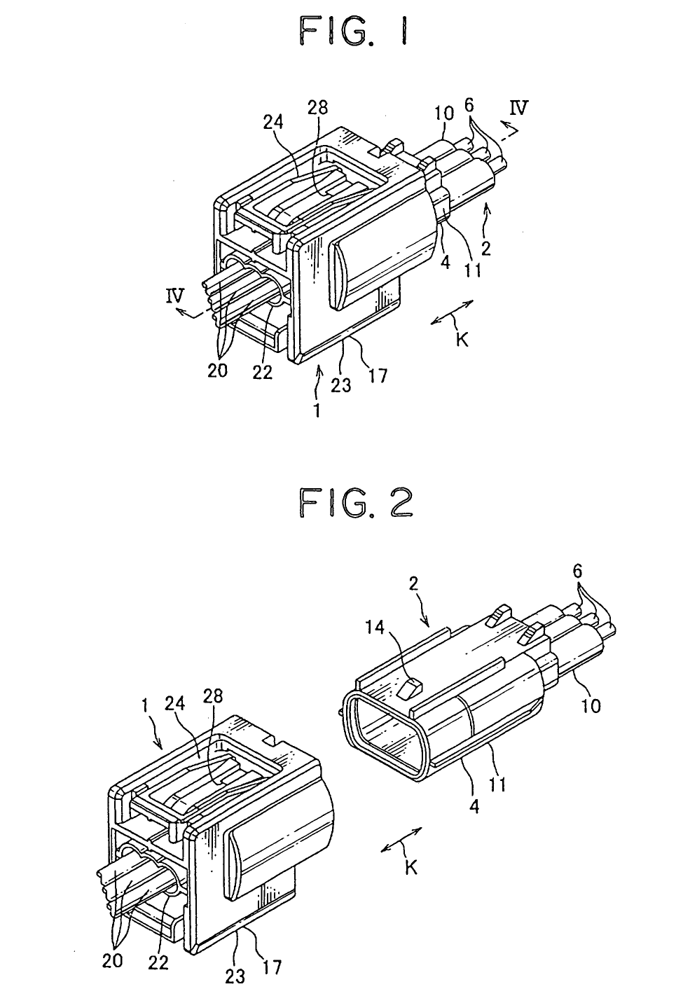

A waterproof connector (hereafter referred to as connector) according to an embodiment of the present invention will be explained with reference to FIGS. 1 to 9. The water proof connector 1 shown in FIG. 1 is connected to a mating connector 2 (shown in FIGS. 1 and 2) to form a wiring harness arranged in a vehicle.

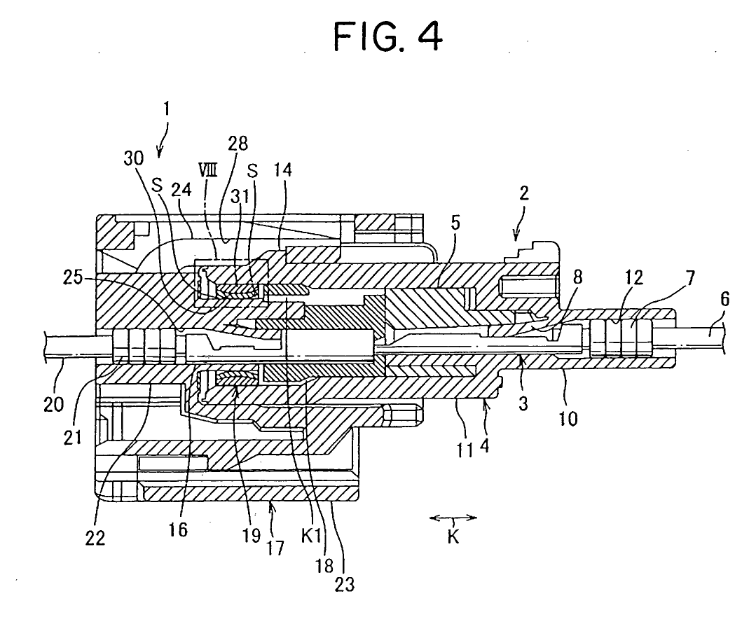

As shown in FIGS. 1, 2, and 4, the mating connector 2 includes a male type terminal fitting (hereafter referred to as male terminal) 3 (shown in FIG. 4), a female type connector housing (hereafter referred to as female housing) 4, and a front holder 5.

The male terminal 3 is made by folding conductive plate metal, and attached to an end of an electric wire 6 to be electrically connected to a core wire of the electric wire 6, and connected to a later-described female terminal 16 of the water proof connector 1. Further, a rubber plug 7 for being in close contact with an inner wall of a later described terminal receiving chamber 12 to keep a gap between the electric wire 6 and the terminal receiving chamber 12 watertight is attached to the electric wire 6.

The female housing 4 is made of insulating synthetic resin. As shown in FIGS. 1, 2, and 4, the female housing 4 includes a box-shaped main body 10 for receiving a plurality of male terminals 3, and a tubular hood 11. Incidentally, in this description, a tubular connector housing into which a main body 22 of a male housing 17 and a front holder 18 are inserted is referred to as a female type connector housing. Incidentally, the female housing 4 corresponds to a mating connector housing described in claims.

A plurality of terminal receiving chambers 12 are formed parallel to each other on the main body. Each terminal receiving chamber 12 receives the male terminal 3. A locking arm 8 to be locked on the male terminal 3 is formed on an inner wall of each terminal receiving chamber 12.

The hood 11 is formed in a tubular shape, and in a boxy (tubular) shape for receiving the later-described main body 22 of the male housing 17 and the front holder 18 in an interior thereof. The hood 11 is extended from the main body 10.

A locking projection 14 as a locking member is formed on an outer wall of the hood 11 positioned at an upper side of FIG. 2. The locking projection 14 is projected from the outer wall of the hood 11. The locking projection 14 is engaged with a later-described locking arm 24.

The front holder 5 is made of insulating synthetic resin, and formed in a tubular shape. The front holder 5 is attached to the main body 10. After the front holder 5 is attached to the main body 10, the male terminal 3 is inserted into an interior of the front holder 5, and the front holder 5 prevents the locking arm 8 from releasing the male terminal 3, namely, prevents the male terminal 3 from falling out of the main body 10 of the female housing 4.

For assembling the mating connector 2, the male terminal 3 to which the electric wire 6 is attached is received in the terminal receiving chamber 12 of the main body 10 of the female housing 4, and the locking arm 8 locks the male terminal 3, then the front holder 5 is attached to the main body 10.

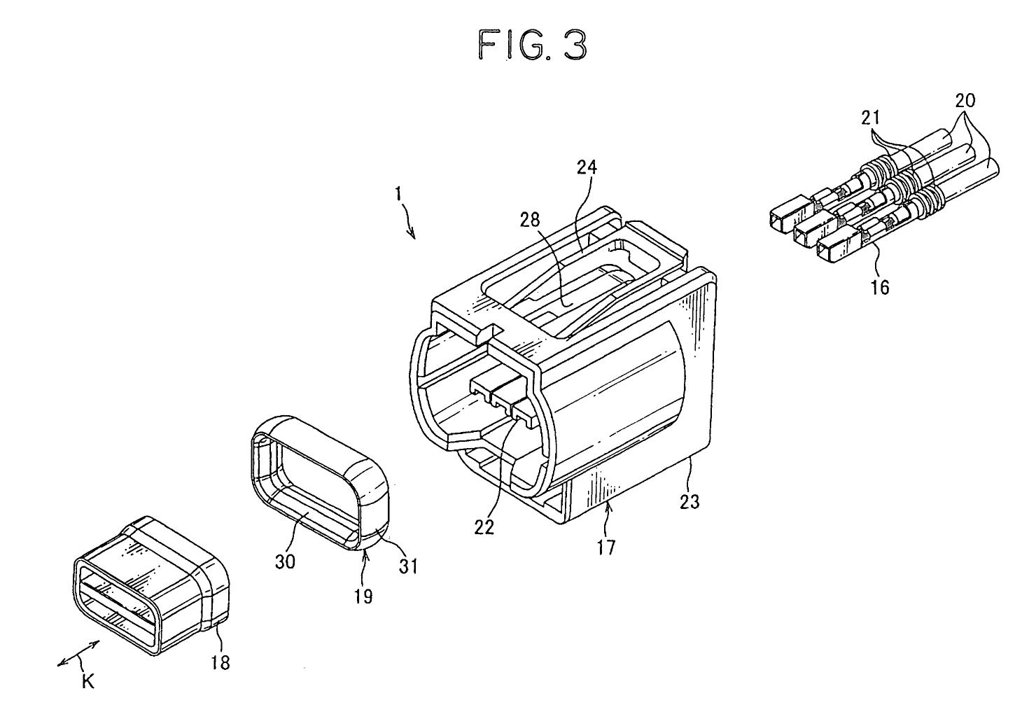

As shown in FIGS. 3 and 4, the connector 1 includes a female type fitting terminal (hereafter referred to as female terminal) 16, a male type connector housing (hereafter referred to as male housing) 17, a front holder 18, and a packing 19.

The female terminal 16 is made by folding conductive metal plate, and attached to an end of an electric wire 20 to be electrically connected to a core wire of the electric wire 20, and connected to the male terminal 3. Further, a rubber plug 21 for being in close contact with an inner wall of a later-described terminal receiving chamber 25 to keep a gap between the electric wire 20 and the terminal receiving chamber 25 watertight is attached to the electric wire 20.

The male housing 17 is made of insulating synthetic resin. As shown in FIGS. 1 to 4, the male housing 17 includes a main body 22, a tubular hood 23, and a locking arm 24. Incidentally, in this description, a connector housing includes a main body 22 to be inserted into the tubular female housing 4 is referred to as a male type connector housing. Incidentally, the male housing 17 corresponds to a connector housing described in claims.

As shown in FIG. 4, the main body 22 is formed in a boxy shape, and a plurality of terminal receiving chambers 25 arranged in parallel to each other is formed on the main body 22. Each terminal receiving chamber 25 receives the female terminal 16. A locking arm 9 to be locked on the female terminal 16 is formed on an inner wall of each terminal receiving chamber 25. The main body 22 and the front holder 18 are inserted into the hood 11 so that the terminal receiving chambers 12, 25 are continued to each other.

The hood 23 is formed in a boxy (tubular) shape receiving the main body 22 in an interior thereof. The hood 23 is extended from an outer edge of the main body 22. An interior of the hood 23 receives the female housing 4.

The locking arm 24 is made of synthetic resin, and elastically deformable. As shown in FIGS. 2 and 3, the locking arm 24 is formed in a bar shape, and a longitudinal direction of the locking arm 24 is parallel to the terminal receiving chamber 25. One end of the locking arm 24 far side from the mating connector 2 is extended from the outer wall of the main body 22, and the other end of the locking arm 24 is a cantilever's free end.

The longitudinal direction of the locking arm 24 is extended along a direction K where the housings 17, 4 are moved close to each other when the housings 17, 4 are connected to each other (hereafter referred to as connecting direction). A locking hole 28 penetrates the locking arm 24.

When the connector housings 17, 4 of the connector 1, 2 are moved close to each other, the locking arm 24 is moved on the locking projection 14, and once elastically deformed in a direction that the other end is moved away from the main body 22. Then, after the locking arm 24 is passed over the locking projection 14 and the locking projection 14 is inserted into the locking hole 28, the other end is moved close to the main body, the locking arm 24 is returned to a neutral position, and the locking projection 14 is positioned in the locking hole 28. Thus, the locking arm 24 is engaged with the locking projection 14 to connect the connector housings 17, 4, namely, connector 1, 2 to each other. At this time, of course, the connector housings 17, 4, namely, connector 1, 2 are moved close to each other to be connected to each other in the connecting direction K.

The front holder 18 is made of insulating synthetic resin. The front holder 18 is formed in a tubular shape, and attached to the main body 22. When the front holder 18 is attached to the main body 22, the front holder 18 prevents the locking arm 9 from releasing the female terminal 16, and prevents the female terminal 16 from falling out of the main body 22, namely, the male housing 17.

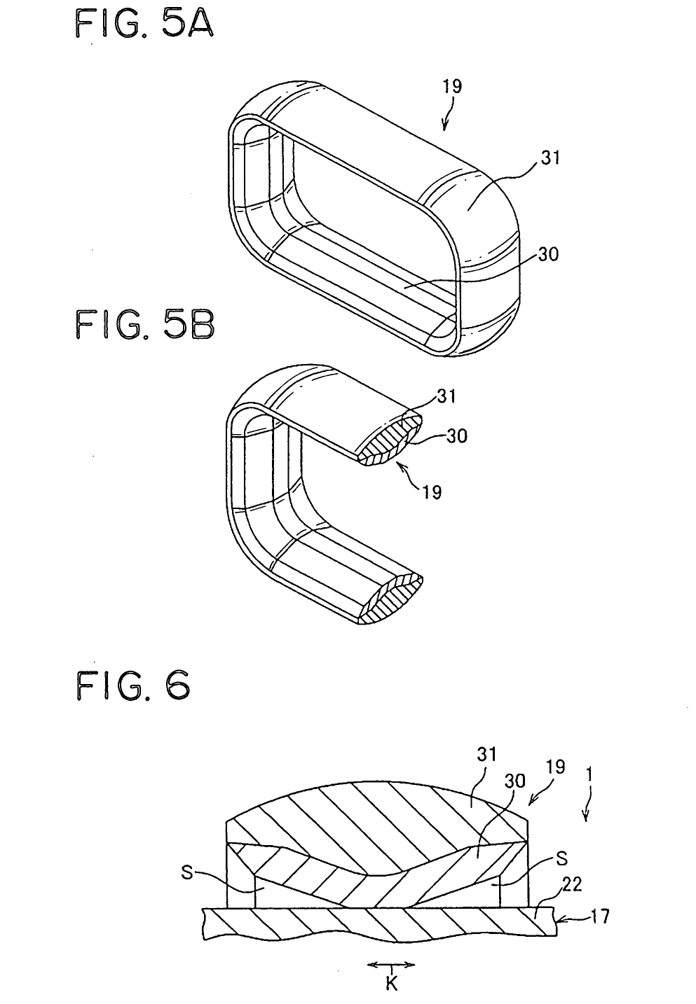

A packing 19 is made of rubbery synthetic resin (namely, elastic material), and as shown in FIGS. 5A, 5B, formed in a ring shape (in a graphic example, a frame shape). Incidentally, in this description, a ring shape means both an annular shape and a frame shape. The main body 22 of the male housing 17 is inserted into an inside of the packing 19. The packing 19 is extended along an outer circumference of the main body 22.

As shown in FIGS. 5A and 5B, the packing 19 integrally includes a hard part 30 and a soft part 31. Both the hard and soft parts 30, 31 are formed in a ring shape (in a graphic example, a frame shape). The soft part 31 is overlapped with an outer periphery of the hard part 30, namely, at a hood 11 of the female housing 4 side. As shown in FIG. 6, when the hard part 30 is attached to the main body 22, a center part of the hard part 30 in the connecting direction K is in close contact with the outer periphery of the main body 22 of the male housing 17, and the hard part 30 has a V-shaped cross-section. Incidentally, in a graphic example, the center part of the hard part 30 in the connecting direction K is attached to the outer periphery of the main body 22 of the male housing 17 with an adhesive. The hard part 30 is made of a first elastic material such as a rubber.

The center part of the hard part 30 in the connecting direction K is mainly in close contact with the main body 22 of the male housing 17 to keep the contact part between the hard part 30 and the main body 22 of the male housing 17 watertight. Further, because the hard part 30 has a V-shaped cross-section, both ends in the connecting direction K are separated from the outer periphery of the main body 22 of the male housing 17 to form a gap S between the hard part 30 and the outer periphery.

The soft part 31 is overlapped with the outer periphery of the hard part 30. A center part of the soft part 31 in the connecting direction K is formed in a convex shape toward the outer periphery of the main body 22 of the male housing 17. Namely, the center part of the soft part 31 in the connecting direction K is formed in a convex shape toward the hood 11 of the female housing 4 connected to the male housing 17. The soft part 31 is made of a second elastic material softer than the first elastic material. The center part of the soft part 31 in the connecting direction K is mainly in close contact with the hood 11 of the female housing 4 connected to the male housing 17 to keep the contact part between the soft part 31 and the hood 11 of the female housing 4 watertight.

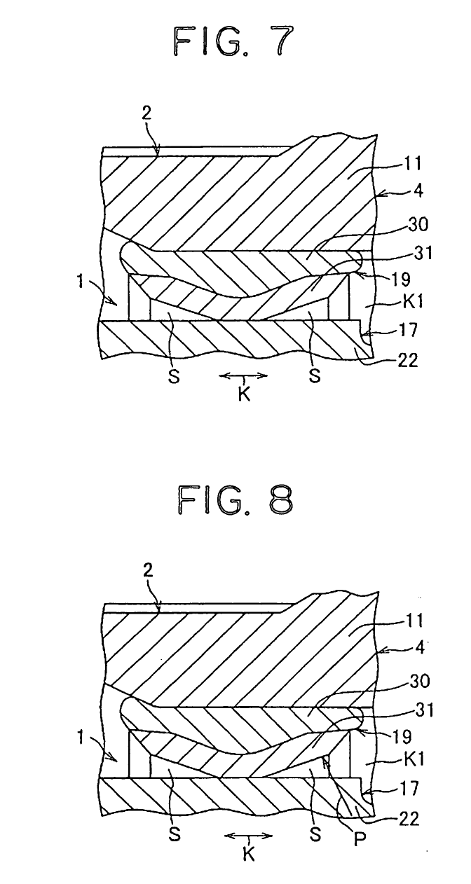

The packing 19 is attached to a whole outer periphery of the main body 22 of the male housing 17. As shown in FIG. 7, when the connector housings 17, 4, namely, the connectors 1, 2 are connected to each other, the packing 19 is in close contact with both the outer periphery of the main body 22 of the male housing 17 and the inner periphery of the hood 11 of the female housing 4 to keep them watertight. Namely, the packing 19 keeps the connecting area between the male housing 17 and the female housing 4 connected to the male housing 17.

For assembling the connector 1, the female terminal 16 to which the electric wire 20 is attached is received in the terminal receiving chamber 25 of the main body 22 of the male housing 17, the locking arm 9 is locked on the female terminal 16, the packing 19 is attached to the outer periphery of the main body 22, and then the front holder 18 is attached to the main body 22.

The connectors 1, 2 are connected to each other in a manner described below. As shown in FIG. 2, the hoods 23, 11 of the housings 17, 4 are disposed to face each other, and then the housings 17, 4 are moved close to each other in a longitudinal direction of the terminal receiving chambers 25, 12, namely, in the connecting direction K.

Then, while the female housing 4 is gradually inserted into the hood 23 of the male housing 17, the main body 22 of the male housing 17 and the front holder 18 are gradually inserted into the hood 11 of the female housing 4. Then, the locking arm 24 and the locking projection 14 are engaged with each other, and the packing 19 comes in close contact with the inner periphery of the hood 11 of the female housing 4. Thus, the connectors 1, 2 are connected to each other. In this state of the connectors 1, 2 connected to each other, the main body 22 of the male housing 17 and the hood 11 of the female housing 4 are separated from each other.

Further, when the housings 17, 4, namely, connectors 1, 2 are connected to each other, because the soft part 31 is made of the second elastic material, the center part of the soft part 31 of the packing 19 is mainly deformed by the hood 11 of the female housing 4. Further, as shown in FIG. 7, when the housings 17, 4, namely, connectors 1, 2 are connected to each other, the center part of the soft part 31 is mainly deformed to be in close contact with the inner periphery of the hood 11 of the female housing 4.

In this state, when differential pressure is generated between a space K1 surrounded by the packing 19, the main body 22 of the male housing 17, and the hood H of the female housing 4 (see FIG. 4, hereafter referred to as a space between the housings 17, 4), and an outside space of the male housing 17, liquid such as water is to be inserted into the space K1 between the housings 17, 4, or a gas in the space K1 between the housings 17, 4 is to leak out of the male housing 17. At this time, the pressure of the liquid or the gas acts the gap S between the hard part 30 of the packing 19 and the outer periphery of the main body 22 of the male housing 17 so that the end of the hard part 30 in the connecting direction K is pressed toward the outside of the main body 22 of the male housing 17, namely, toward. the female housing 4.

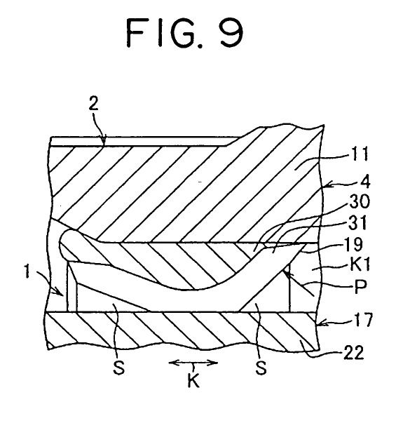

For example, when the gas in the space K1 between the housings 17, 4 is to leak out to the outside of the male housing 17, the pressure P of the gas (indicated by an arrow in FIG. 8) acts on the gap S at the female housing 4 side to press the end of the hard part 30 at the female housing 4 side toward the outside of the main body 22 of the male housing 17, namely, toward the female housing 4. Then, as shown in FIG. 9, the hard part 30, namely, the packing 19 is elastically deformed so that the end of the hard part 30 on which the pressure P acts is moved close to the hood 11 of the female housing 4, and the soft part 31 is in closer contact with the hood 11 of the female housing 4. Thus, when the differential pressure is generated between the space K1 and the outside of the male housing 17 and the liquid such as water is to be inserted into the space K1, or the gas in the space K1 is to leak out to the outside of the male housing 17, the hard part 30, namely, the packing 19 is elastically deformed so that the end of the hard part 30 on which the pressure P acts is moved close to the hood 11 of the female housing 4. Thus, the packing 19 keeps the connecting area between the housings 17, 4 watertight.

Further, according to the embodiment described the above, when the liquid such as water disposed outside of the male housing 17 is to be inserted into the space K1, of course, the liquid such as water is inserted into the gap S at the far side from the female housing 4, and presses the end of the packing 19 at the far side from the female housing 4 toward the inner periphery of the hood 11 of the female housing 4. Then, the hard part 30, namely, the packing 19 is elastically deformed so that the end of the packing 19 at the far side from the locking projection 14 is moved close to the hood 11 of the female housing 4. Thus, the packing 19 keeps the connecting area between the housings 17, 4 watertight.

According to this embodiment, because the hard part 30 has a V-shaped section, and the soft part 31 is overlapped with the hard part 30 at the hood 11 of the female housing 4 side, the gap S is formed between the hard part 30 and the main body 22 of the male housing 17. Therefore, while the male housing 17 is connected to the female housing 4, when the differential pressure is generated between the space K1 and the outside of the male housing 17 and the liquid such as water is to be inserted into the space K1, or the gas in the space K1 is to leak out to the outside of the male housing 17, the pressure P of the liquid or the gas acts on the gap S, and the packing 19 is elastically deformed so that the end of the hard part 30 on which the pressure P acts is moved close to the hood 11 of the female housing 4.

Therefore, when the differential pressure is generated between the space K1 and the outside of the male housing 17, the soft part 31 is in closer contact with the hood 11 of the female housing 4. Therefore, when the liquid such as water is to be inserted into the space K1 between the connectors 17, 4, or the gas in the space K1 between the connectors 17, 4 is to leak out to the outside of the male housing 17, the soft part 31 comes in closer contact with the female housing 4. Thus, the packing 19 surely keeps the connecting area between the housings 17, 4 watertight.

Further, because the soft part 31 is overlapped with the hard part 30, when the male housing 17 is connected to the female housing 4, the female housing 4 presses the soft part 31 and the soft part 31 is easily elastically deformed. Therefore, even when the male housing 17 is easily connected to the female housing 4, the packing 19 keeps the connecting area between the male housing 17 and the female housing 4 watertight.

Further, because the center part of the soft part 31 is in a convex shape, the soft part 31 is surely in close contact with the female housing 4, and the packing 19 surely keeps the connecting area between the housings 17, 4 watertight.

Further, because the connector 1 includes the packing 19, even when the connector 1 is easily connected to the mating connector 2, the packing 19 keeps the connecting area between the male housing 17 and the female housing 4 of the mating connector 2 watertight.

In the embodiment described the above, the soft part 31 is overlapped with the outer periphery of the hard part 30 to form the packing 19. However, according to the present invention, the soft part 31 may be overlapped with an inner periphery of the hard part 30 to form the packing 19. In this case, desirably, the center part of the hard part 30 of the packing 19 is attached to the inner periphery of the hood 11 of the female housing 4. Incidentally, in this case, the female housing 4 corresponds to the connector housing in claims, and the male housing 17 corresponds to the mating connector in claims.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A packing made of elastic member and formed in a ring shape, and attached to the connector housing to keep a connecting area between the connector housing and a mating connector housing watertight,
said packing comprising:
a hard part made of first elastic material, a center part thereof in a connecting direction of the connector housings being in close contact with the connector housing to form a V-shaped section; and
a soft part made of second elastic material softer than the first material, overlapped with the hard part at the mating connector housing side, being in close contact with the mating connector housing.

2. The packing as claimed in claim 1,
wherein a center part of the soft part in the connecting direction of the connector housings is formed in a convex shape toward the mating connector housing.

3. A connector comprising:
a connector housing; and
a packing attached to the connector housing to keep a connecting area between the connector and a mating connector connected to the connector watertight,
wherein the packing is the packing as claimed in claim 1.

4. A connector comprising:
a connector housing; and
a packing attached to the connector housing to keep a connecting area between the connector and a mating connector connected to the connector watertight,
wherein the packing is the packing as claimed in claim 2.
